(19) United States
(12) Patent Application Publication
(10) Pub. No.: US 2016/0196812 A1
(43) Pub. Date: Jul. 7, 2016

(54) MUSIC INFORMATION RETRIEVAL

(71) Applicant: Humtap Inc., San Francisco, CA (US)

(72) Inventors: Tamer Rashad, Mountain View, CA (US); Julien Bloit, Brussels (BE); Leigh Smith, New York, NY (US); Nicole Lusignan, San Francisco, CA (US)

(21) Appl. No.: 14/932,888

(22) Filed: Nov. 4, 2015

Related U.S. Application Data
(63) Continuation-in-part of application No. 14/920,846, filed on Oct. 22, 2015.
Application No. 14/920,846 is a continuation-in-part of application No. 14/931,740, filed on Nov. 3, 2015.
(60) Provisional application No. 62/067,012, filed on Oct. 22, 2014.
(60) Provisional application No. 62/074,542, filed on Nov. 3, 2014.
(60) Provisional application No. 62/075,176, filed on Nov. 4, 2014.

(51) Int. Cl. G10G 1/00; G10H 1/12; G10H 1/00

(52) U.S. Cl. CPC G10G 1/00; G10H 1/0025; G10H 1/125; G10H 2210/071; G10H 2210/066; G10H 2250/135; G10H 2240/131; G10H 2250/015; G10H 2210/145

(57) ABSTRACT

Embodiments of the present invention provide for the receipt of unprocessed audio. Musical information is retrieved or extracted from the same. This musical information may then be used to generate collaborative social co-creations of musical content, identify particular musical tastes, and search for content that corresponds to identified musical tastes.

### CROSS-REFERENCE TO RELATED APPLICATIONS

The present application is a continuation-in-part and claims the priority benefit of U.S. patent application Ser. No. 14/920,846 filed Oct. 22, 2015, which claims the priority benefit of U.S. provisional application No. 62/067,012 filed Oct. 22, 2014; the present application is also a continuation-in-part and claims the priority benefit of U.S. patent application Ser. No. 14/931,740 filed Nov. 3, 2015, which claims the priority benefit of U.S. provisional application No. 62/074,542 filed Nov. 3, 2014; the present application claims the priority benefit of U.S. provisional application No. 62/075,176 filed Nov. 4, 2014. The disclosure of each of the aforementioned applications is incorporated herein by reference.

### BACKGROUND OF THE INVENTION

1. Field of the Invention

The present invention generally relates to retrieving information from a musical selection. More specifically, the present invention relates to identifying the compositional structure of a musical selection thereby allowing for musical search, recommendation, and social co-creation efforts.

2. Description of the Related Art

Music formats have evolved since the introduction of the phonograph in the late 1800s. The phonograph gave way to the gramophone, which in turn lead to vinyl and remains popular today. Vinyl was followed by the 8-track tape, the compact cassette, compact discs, and eventually mini-discs and MP3s. The change in music formats is especially dramatic over the last twenty years with a variety of download, music locker, subscription, and streaming services having come to market.

Technology has unquestionably driven these format changes. This is especially true with respect to the most recent wave of digital content. But the same technologies that have spearheaded the drastic evolution of musical format and delivery remain woefully deficient with respect to knowing what is actually in a musical selection.

Identifying information about music is relatively simple. Data concerning lyricists, instrumentalists, producers, labels, and studios is readily available to the listening public. But this information is nothing more than metadata; data about music. Knowledge of that information is unlikely to contribute to an understanding of what constitutes and makes for an enjoyable listening experience in any meaningful way.

For example, a listener may not necessarily like a particular music track simply because it was written or a produced by the same artist. Consider the English rock band “Radiohead” and it's lead singer Thom Yorke. Thom Yorke also has a solo musical endeavor known as “Atoms for Peace.” Simply because a listener enjoys “Radiohead” does not automatically equate to an enjoyment of “Atoms for Peace” even though the two musical acts share a lead singer.

A listener is more likely to enjoy a particular musical track because of the intangible creative contributions that a particular musician, lyricist, or producer makes to the music. For example: in what key is a particular song written? At what tempo is the song performed? Does the song use a particular instrument or instrumentation? Is the music written in a particular genre? What is the harmonic structure of a particular musical selection?

These nuanced questions concern the fundamental makeup of music at a compositional level. The answers to these questions might help explain why the same listener might enjoy a particular musical track by the aforementioned band “Radiohead” while at the same time enjoying tracks by a dance pop artist such as Britney Spears. But even so-called industry leaders in digital music have no ability to identify the compositional elements of a piece of music.

For example, the online music service Pandora takes songs one-by-one and rates them according to various non-compositional metrics. Pandora then recommends songs with similar ratings to users with a proclivity to relate to songs with certain ratings. The EchoNest, which is now a part of Spotify, identifies high spending users, records data related to plays and skips by those users to build a taste profile. EchoNest/Spotify then makes recommendations to other users having similar profiles. Both services—and many others like them—lack the nuanced attention to (and subsequent identification of) details concerning musical contours, labeling, and compositional DNA. Existing services and methodologies simply look at musical content as singular jumbles of sound and rely upon the aforementioned musical track metadata.

There is a need in the art for identifying and retrieving the compositional elements of a musical selection.

### BRIEF SUMMARY OF THE CLAIMED INVENTION

A first claimed embodiment of the present invention is a method for musical information retrieval. The method includes receiving a musical contribution, extracting musical information, and encoding the extracted musical information in a symbolic abstraction layer.

### BRIEF DESCRIPTION OF THE DRAWINGS

FIG. 1 illustrates an exemplary computing hardware device that may be used to perform musical information retrieval.

FIG. 2 illustrates an exemplary system infrastructure that may be utilized to implement musical information retrieval as well as subsequent processing related thereto.

FIG. 3 illustrates a method for musical information retrieval in a melodic musical contribution.

FIG. 4 illustrates a method for musical information retrieval in a rhythmic musical contribution.

### DETAILED DESCRIPTION

Embodiments of the present invention allow for identifying and retrieving the compositional elements of a music selection—music information retrieval (MIR). Through the use of machine learning and data science, hyper-customized user experiences may be created. By applying MIR to machine learning metrics, users can discover and enjoy new music from new artists and content producers. Similarly, records labels can market and sell music more accurately and effectively. MIR can also contribute to a new scale of music production that is built on an understanding of why a listener actually wants the music that they do rather than marketing a musical concept or artist without real regard for the performed content.

In this context, audio is received to allow for the retrieval and extraction of musical information. Information corresponding to a melody such as pitch, duration, velocity, volume, onsets and offsets, beat, and timbre are extracted. A similar retrieval of musical information occurs in the context of rhythmic taps whereby beats and a variety of onsets are identified. This musical information may then be used to identify particular musical tastes and search for content that corresponds to identified musical tastes. Similar processes may be utilized to aid in the generation of collaborative social co-creations of musical content.

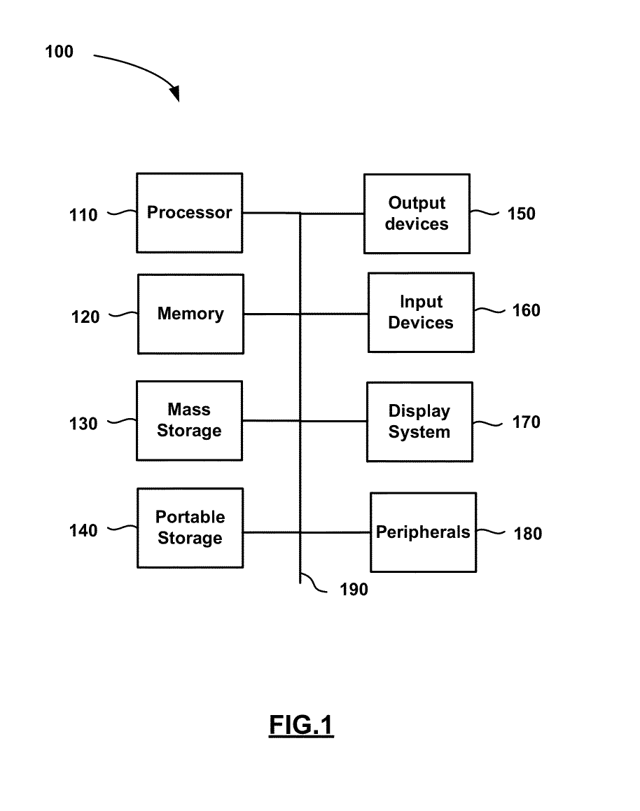

FIG. 1 illustrates an exemplary computing hardware device 100 that may be used to perform musical information retrieval. Hardware device 100 may be implemented as a client, a server, or an intermediate computing device. The hardware device 100 of FIG. 1 is exemplary. Hardware device 100 may be implemented with different combinations of components depending on particular system architecture or implementation needs.

For example, hardware device 100 may be utilized to implement musical information retrieval. Hardware device 100 might also be used for composition and production. Composition, production, and rendering may occur on a separate hardware device 100 or could be implemented as a part of a single hardware device 100. Composition, production, and rendering may be individually or collectively software driven, part of an application specific hardware design implementation, or a combination of the two.

Hardware device 100 as illustrated in FIG. 1 includes one or more processors 110 and non-transitory memory 120. Memory 120 stores instructions and data for execution by processor 110 when in operation. Device 100 as shown in FIG. 1 also includes mass storage 130 that is also non-transitory in nature. Device 100 in FIG. 1 also includes non-transitory portable storage 140 and input and output devices 150 and 160. Device 100 also includes display 170 and well as peripherals 180.

The aforementioned components of FIG. 1 are illustrated as being connected via a single bus 90. The components of FIG. 1 may, however, be connected through any number of data transport means. For example, processor 110 and memory 120 may be connected via a local microprocessor bus. Mass storage 130, peripherals 180, portable storage 140, and display 170 may, in turn, be connected through one or more input/output (I/O) buses.

Mass storage 130 may be implemented as tape libraries, RAID systems, hard disk drives, solid-state drives, magnetic tape drives, optical disk drives, and magneto-optical disc drives. Mass storage 130 is non-volatile in nature such that it does not lose its contents should power be discontinued. Mass storage 130 is non-transitory although the data and information maintained in mass storage 130 may be received or transmitted utilizing various transitory methodologies. Information and data maintained in mass storage 130 may be utilized by processor 110 or generated as a result of a processing operation by processor 110. Mass storage 130 may store various software components necessary for implementing one or more embodiments of the present invention by allowing for the loading of various modules, instructions, or other data components into memory 120.

Portable storage 140 is inclusive of any non-volatile storage device that may be introduced to and removed from hardware device 100. Such introduction may occur through one or more communications ports, including but not limited to serial, USB, Fire Wire, Thunderbolt, or Lightning. While portable storage 140 serves a similar purpose as mass storage 130, mass storage device 130 is envisioned as being a permanent or near-permanent component of the device 100 and not intended for regular removal. Like mass storage device 130, portable storage device 140 may allow for the introduction of various modules, instructions, or other data components into memory 120.

Input devices 150 provide one or more portions of a user interface and are inclusive of keyboards, pointing devices such as a mouse, a trackball, stylus, or other directional control mechanism, including but not limited to touch screens. Various virtual reality or augmented reality devices may likewise serve as input device 150. Input devices may be communicatively coupled to the hardware device 100 utilizing one or more the exemplary communications ports described above in the context of portable storage 140.

FIG. 1 also illustrates output devices 160, which are exemplified by speakers, printers, monitors, or other display devices such as projectors or augmented and/or virtual reality systems. Output devices 160 may be communicatively coupled to the hardware device 100 using one or more of the exemplary communications ports described in the context of portable storage 140 as well as input devices 150.

Display system 170 is any output device for presentation of information in visual or occasionally tactile form (e.g., for those with visual impairments). Display devices include but are not limited to plasma display panels (PDPs), liquid crystal displays (LCDs), and organic light-emitting diode displays (OLEDs). Other displays systems 170 may include surface conduction electron emitters (SEDs), laser TV, carbon nanotubes, quantum dot displays, and interferometric modulator displays (MODs). Display system 570 may likewise encompass virtual or augmented reality devices as well as touch screens that might similarly allow for input and/or output as described above.

Peripherals 180 are inclusive of the universe of computer support devices that might otherwise add additional functionality to hardware device 100 and not otherwise specifically addressed above. For example, peripheral device 180 may include a modem, wireless router, or otherwise network interface controller. Other types of peripherals 180 might include webcams, image scanners, or microphones although a microphone might in some instances be considered an input device.

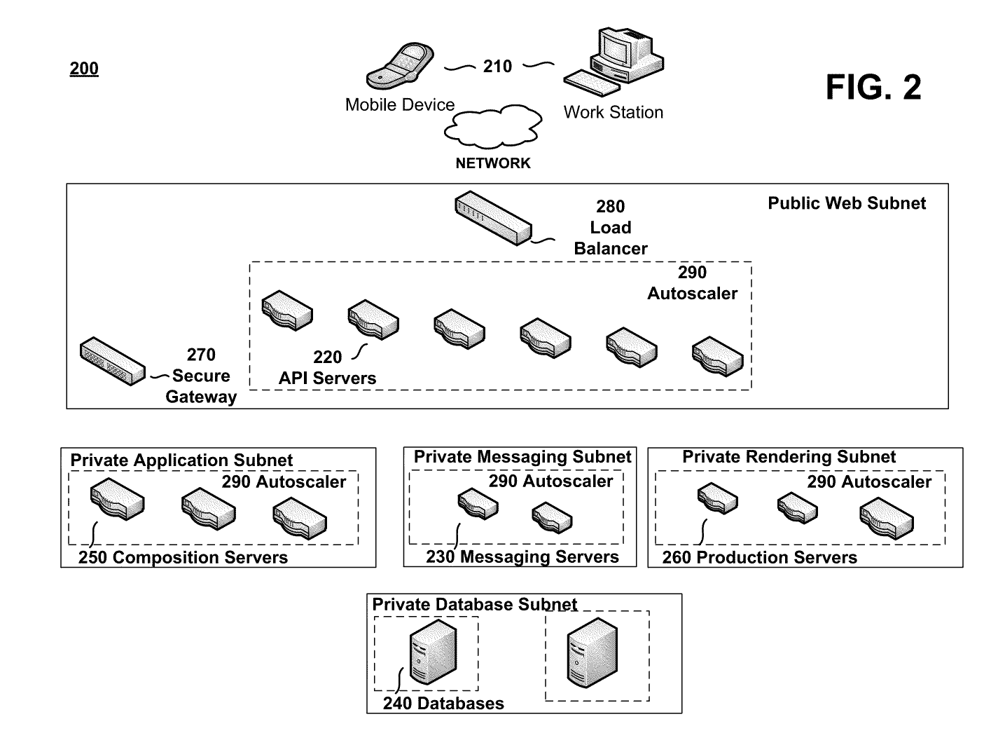

FIG. 2 illustrates an exemplary system infrastructure that may be utilized to implement musical information retrieval as well as subsequent processing related thereto. While generally summarized herein, other aspects of such a system infrastructure may be found in U.S. provisional application No. 62/075,160 filed Nov. 4, 2014 and U.S. utility application Ser. No. ______ , filed concurrently herewith.

The system infrastructure 200 of FIG. 2 includes a front end application 210 that might execute and operate on a mobile device or a workstation, application programming interface (API) servers 220, messaging servers 230, and database servers 240. FIG. 2 also includes composition servers 250 and production servers 260. Optional infrastructure elements in FIG. 2 include a secure gateway 270, load balancer 280, and autoscalers 290.

The front end application 210 provides an interface to allow users to introduce musical contributions. Such contributions may occur on a mobile device as might be common amongst amateur or non-professional content creators. Contributions may also be provided at a professional workstation or server system executing an enterprise version of the application 210. The front end application 210 connects to the API server 220 over a communication network that may be public, proprietary, or a combination of the foregoing. Said network may be wired, wireless, or a combination of the foregoing.

The API server 220 is a standard hypertext transfer protocol (HTTP) server that can handle API requests from the front end application 210. The API server 220 listens for and responds to requests from the front end application 210, including but not limited to musical contributions. Upon receipt of a contribution, a job or “ticket” is created that is passed to the messaging servers 230.

Messaging server 230 is an advanced message queuing protocol (AMQP) message broker that allows for communication between the various back-end components of the system infrastructure via message queues. Multiple messaging servers may be run using an autoscaler 290 to ensure messages are handled with minimized delay.

Database 240 provides storage for system infrastructure 200. Database 240 maintains instances of musical contributions from various users. Musical contributions may be stored on web accessible storage services such as Amazon AWS Simple Storage Service (AWS S3), with the Database Server 240 storing web accessible addresses to sound and other data files corresponding to those musical contributions. Database 240 may also maintain user information, including but not limited to user profiles, data associated with those profiles (such as user tastes, search preferences, and recommendations), information concerning genres, compositional grammar rules and styles as might be used by composition server 250 and instrumentation information as might be utilized by production server 260.

Composition server 250 “listens” for tickets that are queued by messaging server 230 and maintained by database 240 and that reflect the need for execution of the composition and production processes. Composition server 250 maintains a composition module that is executed to generate a musical blueprint in the context of a given musical genre for rendering to sound data by the production server 260. The composition server 250 will then create rendering tickets on the messaging server 230. The production server 260 retrieves tickets for rendering and the score or blueprint as generated through the execution of the composition module and applies instrumentation to the same. The end result of the composition process is maintained in database 240.

System infrastructure 200 of FIG. 2 also includes optional load balancer 280. Load balancer 280 acts as a reverse proxy and distributes network or application traffic across a number of duplicate API servers 220. Load balancer 280 operates to increase the capacity (i.e., concurrent users) and reliability of applications like front end application 210 that interact with overall network infrastructure 200. Auto scaler 290 helps maintain front end application 210 availability and allows for the automatic scaling of services (i.e., capacity) according to infrastructure administrator defined conditions. Auto scaler 290 can, for example, automatically increase the number of instances of composition 250, messaging 230 and production 260 servers during demand spikes to maintain performance and decrease capacity during lulls to reduce network infrastructure costs.

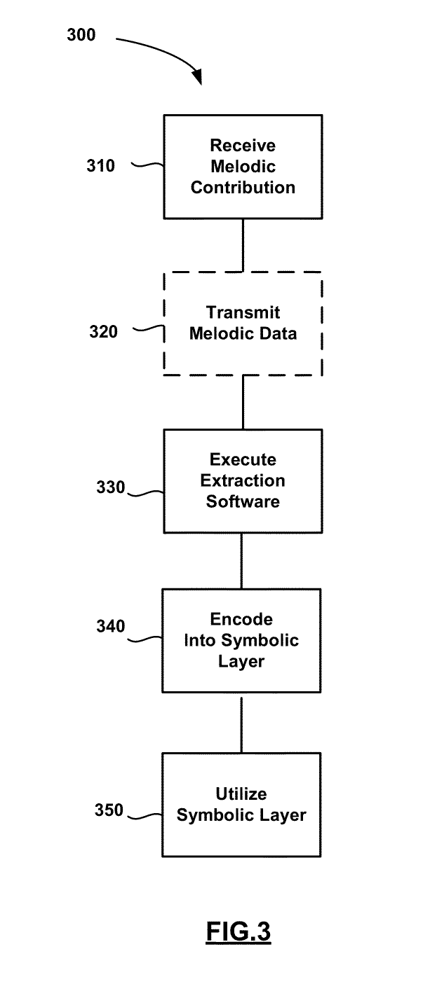

FIG. 3 illustrates a method 300 for musical information retrieval in a melodic musical contribution. The method 300 illustrated in FIG. 3 generally involves receiving a hum or other melodic utterance at a microphone or other audio receiving device in step 310. The hum or melodic utterance might be generated by a human being or could be a live or pre-recorded melody such as a concert or song played on the radio. The microphone or audio receiving device is in communication with a software application for collection of such information.

The microphone or audio receiving device may be integrated with or coupled to a hardware device like that illustrated in FIG. 1. The microphone or audio receiving device might also be a part of a mobile device with network communication capabilities. The mobile device might transmit data related to the hum or melodic utterance to a computing device with requisite processing power and memory capabilities to perform the various processes described herein. In some instances, the mobile device may possess said processing and memory capabilities.

If necessary, the application executes in step 320 to provide for the transmission of information to a computing device like hardware device 100 of FIG. 1. Transmission of the collected melodic information may occur over a system infrastructure like that shown in FIG. 2. In some instances, however, the collected melodic information may already be resident at the hardware device performing the requisite processing. The hardware device may, in some instances, be a mobile device like an iPhone or iPad or any number of mobile devices running the Android operating system.

Upon receipt of the melodic musical contribution, the hardware device 100 or a mobile device with similar processing capabilities executes extraction software at step 330. Execution of the extraction or composition software extracts various elements of musical information from the melodic utterance. This information might include, but is not limited to, pitch, duration, velocity, volume, onsets and offsets, beat, and timbre. The extracted information is encoded into a symbolic data layer at step 340.

Musical information is extracted from the melodic musical utterance in step 330 to allow the computation of various audio features that are subsequently or concurrently encoded in step 340. Extraction may occur through the use of certain commercially available extraction tools like the Melodia extraction vamp plug-in tool. Melodia estimates the pitch of the melody in a polyphonic or monophonic musical contribution. An algorithm estimates the fundamental frequency of the contribution by estimating when the melody is and is not present (i.e. voicing detection) and the pitch of the melody when it is determined to in fact be present.

The accuracy or confidence measure of any pitch determination, especially when multiple pitch candidates are present, may alternatively or further be adjudged through the use of YIN. YIN is an algorithm that estimates fundamental frequency and is based on various auto-correlation methodologies. YIN utilizes a signal model that may be extended to handle various forms of aperiodicity.

Music information retrieval and extraction may also involve the use of the Essentia open source library. Essentia is a library of reusable algorithms that implement audio input/output functionality, standard digital processing blocks, statistical characterization of data, and large sets of spectral, temporal, tonal, and high-level music descriptors. Essentia may also be used to compute high-level descriptions of music through generation of classification models.

Extraction of musical information from the melodic signal in step 330 may occur in the context of uniform 12 millisecond frames. While other frame lengths may be utilized in the extraction process at step 330, the use of uniform frames allow for quantization of a sequence of features along with the aforementioned fundamental frequency and confidence values. In parallel with the quantization is the computation of loudness and beat values. Individual notes may also be extracted by extracting patterns in music via Markov chains. The note information and beat detection may then be realigned as necessary to translate notes and timing information into both absolute time and musical time.

Absolute time is that time affected by tempo. For example, certain events may occur sooner or later dependent upon the speed or pace of a given piece of music. A particular note value (such as a quarter note) is specified as the beat and the amount of time between successive beats is a specified fraction of a minute (e.g., 120 beats per minute). Musical time is that time identified by a measure and a beat. For example, measure two, beat two. Absolute time in comparison to musical time can be reflected as seconds versus metered bars and beats.

The foregoing extracted musical information is reflected as a tuple—an ordered list of elements with an n-tuple representing a sequence of n elements with n being a non-negative integer—as used in relation to the semantic web. Tuples are usually written by listing elements within parenthesis and separate by commas (e.g., (2, 7, 4, 1, 7)). The tuples are static in size with the same number of properties per note. Tuples are then migrated into the symbolic layer at step 340.

The symbolic layer into which extracted musical information is encoded allows for the flexible representation of audio information as it transitions from the audible analog domain to the digital data domain. In this regard, the symbolic layer pragmatically operates as sheet music. While MIDI-like in nature, the symbolic layer of the presently disclosed invention is not limited to or dependent upon MIDI (Musical Instrument Digital Interface). MIDI is a technical standard allowing for electronic musical instruments and computing devices to communicate with one another. MIDI uses event messages to specify notation, pitch, and velocity; control parameters corresponding to volume and vibrato; and clock signals that synchronize tempo. The symbolic layer of the present invention operates in a fashion similar to MIDI; the symbolic layer represents music as machine input-able information.

Through use of this symbolic layer, other software modules and processing routines are able to utilize retrieved musical information for the purpose of applying compositional rules, instrumentation, and ultimately rendering of content for playback in the case of social co-creation of music. Such further utilization or processing takes place at step 350 and will vary depending on the particular intent as to the future use of any musical contribution. Music content may ultimately be passed as an actual MIDI file. For the purposes of using musical information retrieval to generate a subsequent composition process, the abstract symbolic layer is passed versus the likes of a production file.

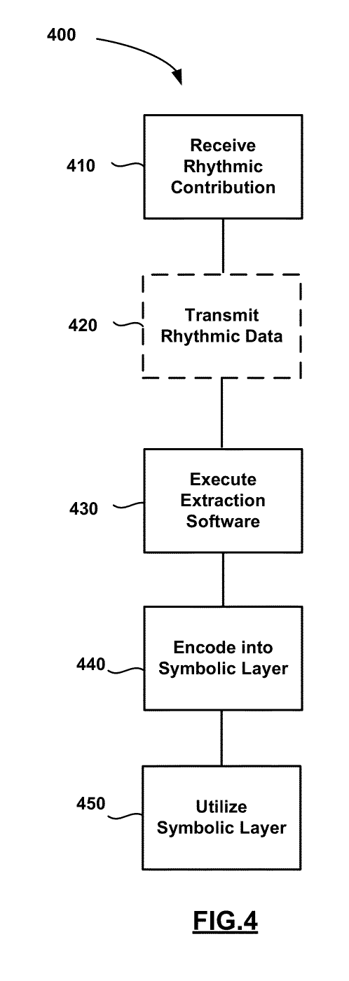

FIG. 4 illustrates a method 400 for musical information retrieval in a rhythmic musical contribution. The method 400 of FIG. 4 is similar in some respects to the information retrieval process for a melodic contribution as discussed in the context of FIG. 3. In this regard, the method 400 of FIG. 4 includes receiving a tap or other rhythmic contribution at a microphone or other audio receiving device in step 410. The microphone or audio receiving device is again in communication with a software application that executes in step 420 to provide—if necessary—for the transmission of information to a computing device like hardware device 100 of FIG. 1. Transmission of the rhythmic information may again occur over a system infrastructure like that described in FIG. 2 and discussed above.

Upon receipt of the rhythmic musical contribution, hardware device 100 executes extraction or composition software at step 430 to extract various musical data features. This information might include, but is not limited to high frequency content, spectral flux, and spectral difference. The extracted information is encoded into the symbolic layer at step 440; extraction of this information may take place through the use of the Essentia library as described above. Extracted information may be made available for further use at step 450. Such further uses may similar to or some instances identical or in conjunction with those described with respect to step 250 in FIG. 2.

High frequency content is a measure taken across a signal spectrum such as a short term Fourier transform. This measure can be used to characterize the amount of high-frequency content in a signal by adding the magnitudes of the spectral bins while multiplying each magnitude by the bin position proportional to frequency as follows:

$$HFC = {\sum }_{i = 0}^{N - 1} i \vert X ( i ) \vert$$

where X(k) is a discrete spectrum with N unique points. Through the extraction of high frequency content, musical information concerning onset detection may be extracted.

Spectral flux is a measure of change in the power spectrum of a signal as calculated by comparing the power spectrum of one frame against the frame immediately prior. Spectral flux can be used to determine the timbre of an audio signal. Spectral flux may also be used for onset detection.

Spectral differencing is a methodology for detecting downbeats in musical audio given a sequence of beat times. A robust downbeat extractor is useful in the context of music information retrieval. Downbeat extraction through spectral differencing allows for rhythmic pattern analysis for genre classification, the indication of likely temporal boundaries for structural audio segmentation, and otherwise improves the robustness of beat tracking.

The use of music information retrieval information related to high frequency content, spectral flux, and spectral difference is to answer a simple question: “is there a tap or some other rhythmic downbeat present?” If music information extraction indicates the answer to be yes, an examination of the types of sounds—or tap polyphony—that generated a given tap or downbeat is undertaken. For example, a tap or downbeat might be grouped into one of several sounds classes such as a tap on a table, a tab on a chair, a tap in the human body and so forth. Information related to duration or pitch is of lesser to no value. Information concerning outset, class, velocity, and loudness may be encoded unto a tuple that is, in turn, integrated into the symbolic layer.

In an a further embodiment of the present invention, a de-noising operation may take place using source separation algorithms. By executing and applying such an algorithm, random characteristics that do not match the overall input may be identified and removed from the audio sample. For example, a musical contribution might be interrupted by a ringing doorbell or a buzz saw. These anomalies would present as inconsistent with onsets in the case of a rhythmic tap or a fundamental frequency (or at least a confident one) in the case of a melodic contribution. Source separation might also be utilized to identify and differentiate between various contributors, humming modes or styles, as well as singing. Source separation might, in this regard, be used to refine note extraction and identify multiple melodic streams.

Another embodiment might utilize evaluation scripts to aid in learning and training of a musical information retrieval package. Users could manually annotate musical contributions such that the script may score the accuracy of characterization of various elements of musical information including but not limited frequency and notation accuracy, tempo, and identification of onsets or downbeats.

The foregoing detailed description has been presented for purposes of illustration and description. The foregoing description is not intended to be exhaustive or to the present invention to the precise form disclosed. Many modifications and variations of the present invention are possible in light of the above description. The embodiments described were chosen in order to best explain the principles of the invention and its practical application to allow others of ordinary skill in the art to best make and use the same. The specific scope of the invention shall be limited by the claims appended hereto.

What is claimed is:

1. A method for musical information retrieval, the method comprising:
receiving a musical contribution;
extracting musical information; and
encoding the extracted musical information in a symbolic abstraction layer for subsequent processing.

2. The method of claim 1, wherein the musical contribution is melodic and the extracted musical information is one or more of pitch, duration, velocity, onsets, beat, and timbre.

3. The method of claim 1, wherein the musical contribution is rhythmic and the extracted musical information is a downbeat having velocity and that is grouped into one or more sound classes.

4. The method of claim 1, wherein the extraction and encoding are concurrent.

5. The method of claim 1, wherein the encoding is subsequent to the extraction.

6. The method of claim 1, wherein the musical contribution is a polyphonic melodic contribution and the extraction estimates the pitch of the contribution.

7. The method of claim 1, wherein the musical contribution is a monophonic melodic contribution and the extraction estimates the pitch of the contribution.

8. The method claim 1, wherein the extraction estimates the fundamental frequency of the musical contribution by determining when a melody having pitch is present.

9. The method of claim 8, wherein the determination of pitch includes an accuracy or confidence measure.

10. The method of claim 9, wherein the determination of pitch includes the use of the YIN algorithm that includes an auto-correlation methodology.

11. The method of claim 9, wherein the determination of pitch includes the use of the Essentia open source library thereby computing a high-level classification of music using a classification model.

12. The method of claim 1, wherein the extraction utilizes uniform frames.

13. The method of claim 12, wherein the uniform frames allows for quantization of a sequence of features, a determination of a fundamental frequency and confidence value.

14. The method of claim 1, wherein the extraction utilizes a Markov chain.

14. The method of claim 1, further comprising realigning note information and beat detection into both absolute time and musical time.

15. The method of claim 14, wherein absolute time correlates to tempo.

16. The method of claim 14, wherein musical time correlates to time versus metered bars and beats.

17. The method of claim 1, wherein the extracted musical information is reflected an ordered list of elements with an n-tuple representing a sequence of n elements and n is a non-negative integer.

18. The method of claim 17, wherein the ordered list of elements is encoded into the symbolic abstraction layer as a tuple having static size and having a consistent number of properties with respect to each musical note.

19. The method of claim 1, wherein the symbolic layer allows for the flexible representation of audio information from the audible analog domain to the digital data domain.

20. The method of claim 19, wherein the symbolic layer represents music as machine input-able information.

21. The method of claim 1, wherein the subsequent processing includes application of compositional rules.

22. The method of claim 1, wherein the subsequent processing includes application of instrumentation.

23. The method of claim 1, wherein the subsequent processing includes rendering of content for playback during social co-creation of music.

24. The method of claim 1, wherein the musical contribution is rhythmic and the extracted musical information includes high frequency content measured across a signal spectrum.

25. The method of claim 1, wherein the musical contribution is rhythmic and the extracted musical information includes spectral flux that measures a change in the power spectrum of a signal as calculated by comparing the power spectrum of one frame against the frame immediately prior.

26. The method of claim 1, wherein the musical contribution is rhythmic and the extracted musical information includes spectral differencing that detects downbeats in musical audio given a sequence of beat times.

27. The method of claim 1, further comprising implementing a de-noising operation that eliminates random characteristics that do not match the overall input identified in the musical contribution.

28. The method of claim 27, wherein the de-noising operation includes source separation.

29. The method of claim 1, further comprising utilizing an evaluation script to train a musical retrieval package.

30. The method of claim 29, wherein the evaluation script includes manual annotations of musical contributions.
